(19) United States
(12) Patent Application Publication
(10) Pub. No.: US 2024/0107346 A1
(43) Pub. Date: Mar. 28, 2024

(54) NETWORK ENERGY SAVINGS MODE ASSOCIATED WITH CROSS-LINK INTERFERENCE

(71) Applicant: QUALCOMM Incorporated, San Diego, CA (US)

(72) Inventors: Muhammad Sayed Khairy ABDELGHAFFAR, San Jose, CA (US); Wanshi CHEN, San Diego, CA (US); Ahmed Attia ABOTABL, San Diego, CA (US); Qian ZHANG, Basking Ridge, NJ (US); Abdelrahman Mohamed Ahmed Mohamed IBRAHIM, San Diego, CA (US); Juan MONTOJO, San Diego, CA (US)

(21) Appl. No.: 18/364,267

(22) Filed: Aug. 2, 2023

Related U.S. Application Data
(60) Provisional application No. 63/377,170, filed on Sep. 26, 2022.

(51) Int. Cl. H04W 24/08; H04W 24/02

(52) U.S. Cl. CPC H04W 24/08; H04W 24/02

(57) ABSTRACT

Various aspects of the present disclosure generally relate to wireless communication. In some aspects, a first network entity may generate a message that includes information associated with a network energy saving (NES) mode of the first network entity in association with a timing of cross-link interference (CLI) measurement resources. The first network entity may transmit the message to a second network entity. Numerous other aspects are described.

### CROSS-REFERENCE TO RELATED APPLICATION

This Patent application claims priority to U.S. Provisional Patent Application No. 63/377,170, filed on Sep. 26, 2022, entitled “NETWORK ENERGY SAVINGS MODE ASSOCIATED WITH CROSS-LINK INTERFERENCE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for messaging for a network energy savings mode associated with cross-link interference.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first network entity. The method may include generating a message that includes information associated with a network energy saving (NES) mode of the first network entity in association with a timing of cross-link interference (CLI) measurement resources. The method may include transmitting the message to a second network entity.

Some aspects described herein relate to a method of wireless communication performed by a second network entity. The method may include receiving a message that includes information associated with an NES mode of a first network entity in association with a timing of CLI measurement resources. The method may include performing CLI measurements based at least in part on the information and an energy status of the second network entity.

Some aspects described herein relate to an apparatus of a first network entity for wireless communication. The apparatus may include one or more memories and one or more processors coupled to the one or more memories. The one or more processors may be individually or collectively configured to generate a message that includes information associated with an NES mode of the first network entity in association with a timing of CLI measurement resources. The one or more processors may be individually or collectively configured to transmit the message to a second network entity.

Some aspects described herein relate to an apparatus of a second network entity for wireless communication. The apparatus may include one or more memories and one or more processors coupled to the one or more memories. The one or more processors may be individually or collectively configured to receive a message that includes information associated with an NES mode of a first network entity in association with a timing of CLI measurement resources. The one or more processors may be individually or collectively configured to perform CLI measurements based at least in part on the information and an energy status of the second network entity.

Some aspects described herein relate to a non-transitory computer-readable medium that stores a set of instructions for wireless communication by a first network entity. The set of instructions, when executed by one or more processors of the first network entity, may cause the first network entity to generate a message that includes information associated with an NES mode of the first network entity in association with a timing of CLI measurement resources. The set of instructions, when executed by one or more processors of the first network entity, may cause the first network entity to transmit the message to a second network entity.

Some aspects described herein relate to a non-transitory computer-readable medium that stores a set of instructions for wireless communication by a second network entity. The set of instructions, when executed by one or more processors of the second network entity, may cause the second network entity to receive a message that includes information associated with an NES mode of a first network entity in association with a timing of CLI measurement resources. The set of instructions, when executed by one or more processors of the second network entity, may cause the second network entity to perform CLI measurements based at least in part on the information and an energy status of the second network entity.

Some aspects described herein relate to an apparatus for wireless communication. The apparatus may include means for generating a message that includes information associated with an NES mode of the apparatus in association with a timing of CLI measurement resources. The apparatus may include means for transmitting the message to another apparatus.

Some aspects described herein relate to an apparatus for wireless communication. The apparatus may include means for receiving a message that includes information associated with an NES mode of another apparatus in association with a timing of CLI measurement resources. The apparatus may include means for performing CLI measurements based at least in part on the information and an energy status of the apparatus.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity (e.g., base station) in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of using a transmit inactivity period, in accordance with the present disclosure.

FIGS. 5A-5C are diagrams illustrating examples of full-duplex communication in accordance with the present disclosure.

FIG. 6 is a diagram illustrating an example of full-duplex communication modes, in accordance with the present disclosure.

FIG. 7 is a diagram illustrating an example of transmitting information associated with a network entity network energy saving (NES) mode, in accordance with the present disclosure.

FIG. 8 is a diagram illustrating examples of exchanging information about NES modes, in accordance with the present disclosure.

FIG. 9 is a diagram illustrating an example of NES mode information associated with cross-link interference measurement resources, in accordance with the present disclosure.

FIG. 10 is a diagram illustrating an example process performed, for example, by a first network entity, in accordance with the present disclosure.

FIG. 11 is a diagram illustrating an example process performed, for example, by a second network entity, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

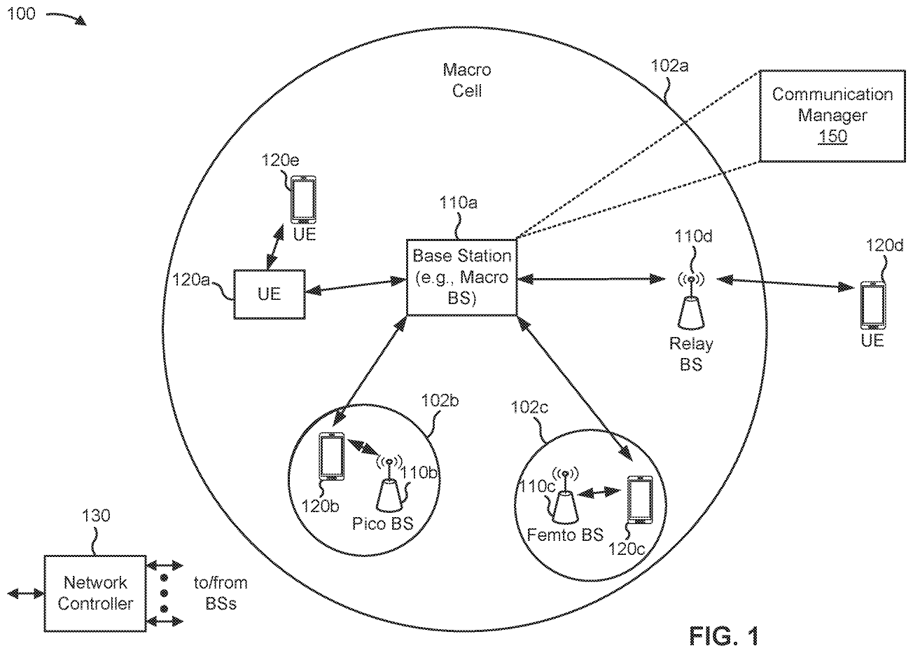

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Entity B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the terms “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations and/or one or more virtual base station functions. For example, in some aspects, two or more base station functions may be instantiated on a single device. In some aspects, the terms “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BS s, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first network entity (e.g., base station 110) may include a communication manager 150. As described in more detail elsewhere herein, the communication manager 150 may generate a message that includes information associated with a network energy saving (NES) mode of the first network entity in association with a timing of cross-link interference (CLI) measurement resources. The communication manager 150 may transmit the message to a second network entity. Additionally, or alternatively, the communication manager 150 may perform one or more other operations described herein.

In some aspects, a second network entity (e.g., base station 110) may include a communication manager 150. As described in more detail elsewhere herein, the communication manager 150 may receive a message that includes information associated with an NES mode of a first network entity in association with a timing of CLI measurement resources. The communication manager 150 may perform CLI measurements based at least in part on the information and an energy status of the second network entity. Additionally, or alternatively, the communication manager 150 may perform one or more other operations described herein.

As indicated above, FIG. 1 is provided as an example. Other examples may differ from what is described with regard to FIG. 1.

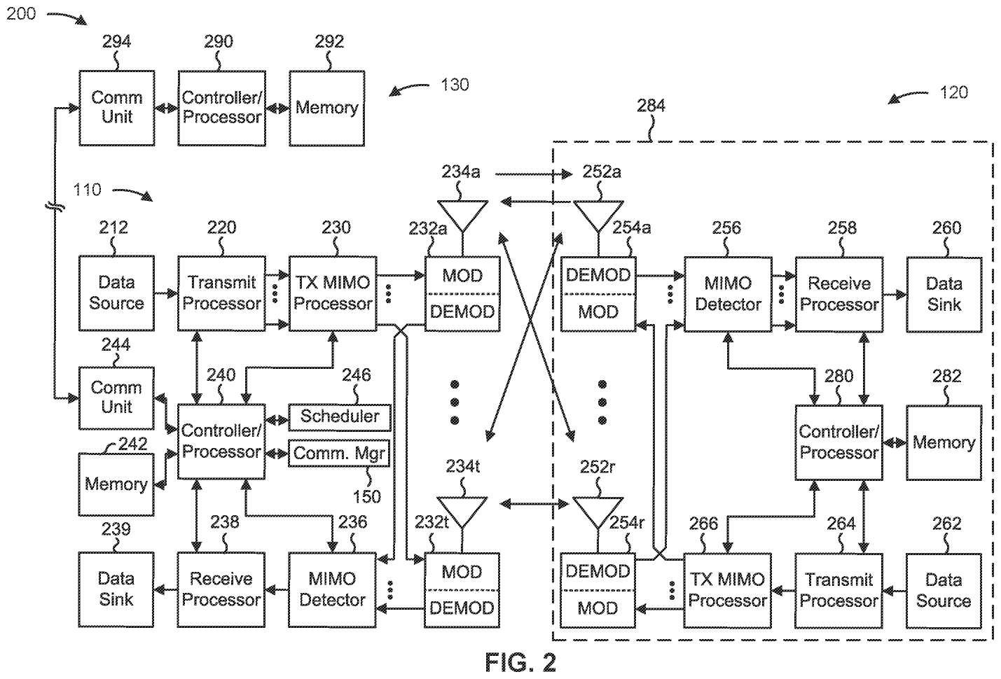

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292 (e.g., one or more memories). The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

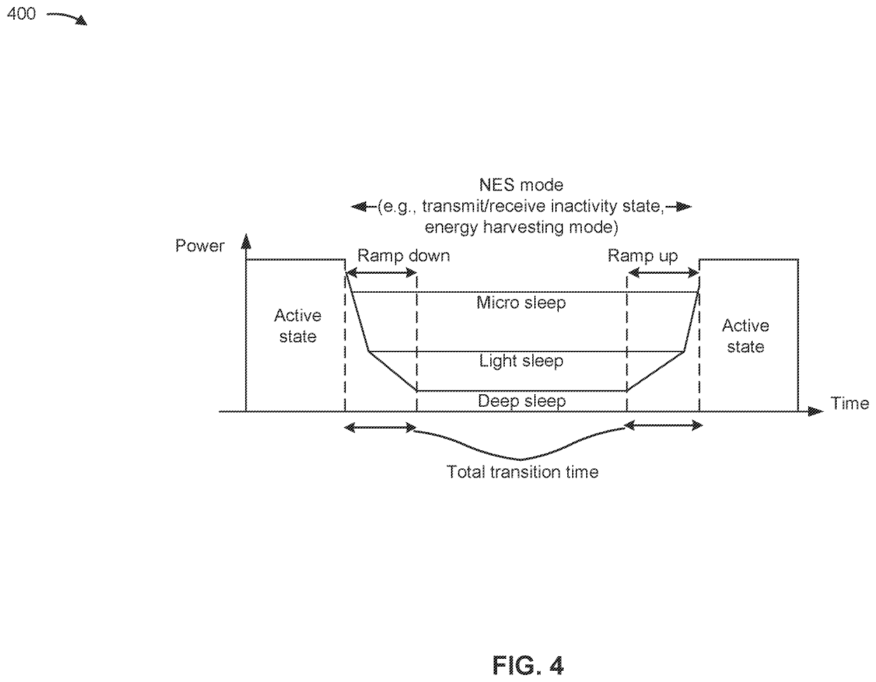

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 (e.g., one or more memories) to perform aspects of any of the methods described herein (e.g., with reference to FIGS. 4-12).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

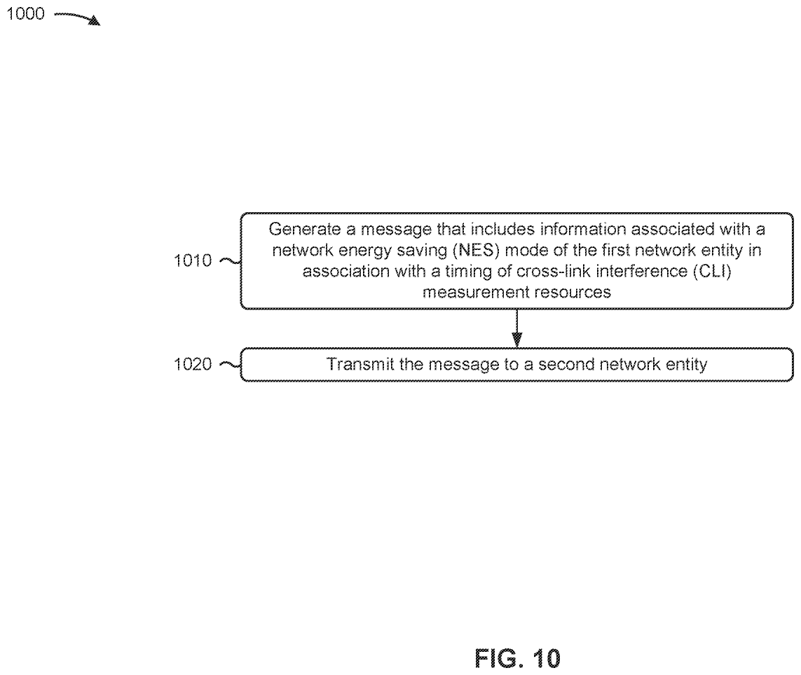

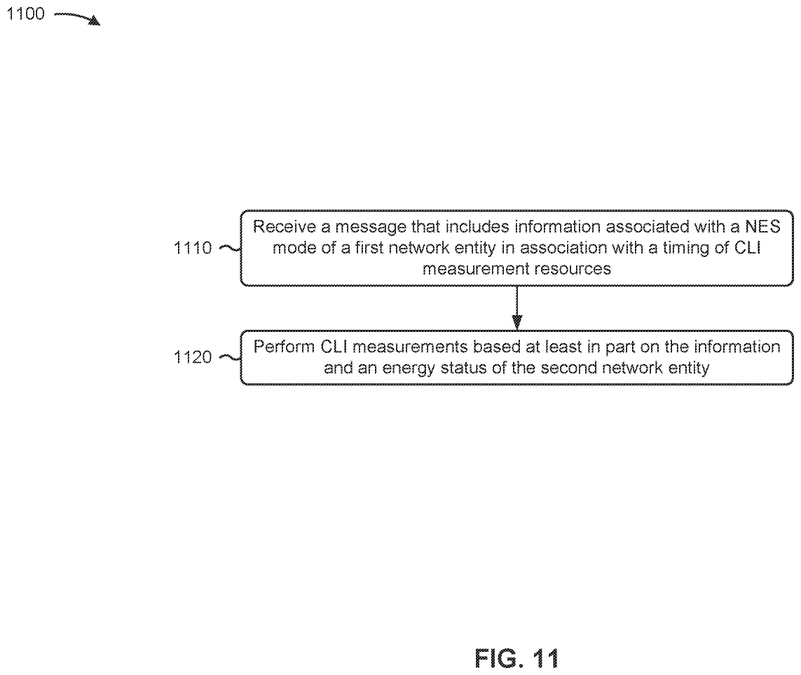

A controller/processor of a network entity (e.g., the controller/processor 240 of the base station 110), the controller/processor 280 of the UE 120, and/or any other component(s) of FIG. 2 may perform one or more techniques for indicating an NES mode associated with CLI measurements, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a first network entity (e.g., base station 110) includes means for generating a message that includes information associated with an NES mode of the first network entity in association with a timing of CLI measurement resources (e.g., using controller/processor 240, memory 242); and/or means for transmitting the message to a second network entity (e.g., using controller/processor 240, transmit processor 220, TX MIMO processor 230, modem 232, antenna 234, memory 242). In some aspects, the means for the first network entity to perform operations described herein may include, for example, communication manager 150, transmit processor 220, TX MIMO processor 230, modem 232, antenna 234, MIMO detector 236, receive processor 238, controller/processor 240, memory 242, scheduler 246, or any combination thereof.

In some aspects, a second network entity (e.g., base station 110) includes means for receiving a message that includes information associated with an NES mode of a first network entity in association with a timing of CLI measurement resources (e.g., using antenna 234, modem 232, MIMO detector 236, receive processor 238, controller/processor 240, memory 242); and/or means for performing CLI measurements based at least in part on the information and an energy status of the second network entity (e.g., using antenna 234, modem 232, MIMO detector 236, receive processor 238, controller/processor 240, memory 242). In some aspects, the means for the second network entity to perform operations described herein may include, for example, communication manager 150, transmit processor 220, TX MIMO processor 230, modem 232, antenna 234, MIMO detector 236, receive processor 238, controller/processor 240, memory 242, scheduler 246, or any combination thereof.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

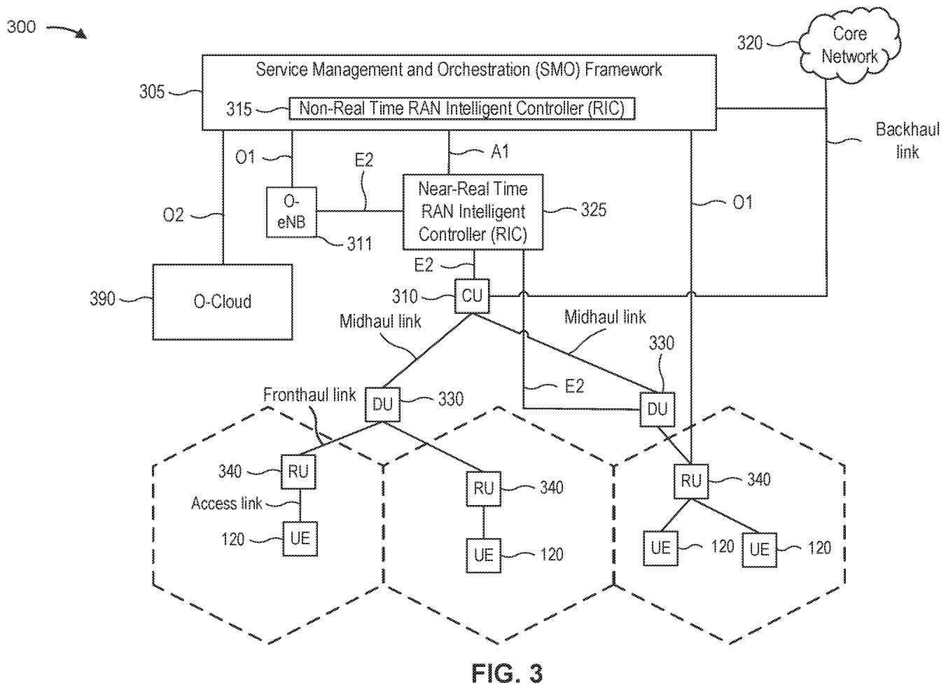

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include a TRP, a relay station, a passive device, an intelligent reflective surface (IRS), or other components that may provide a network interface for or serve a UE, mobile station, sensor/actuator, other wireless device, or any combination thereof.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 is a diagram illustrating an example 400 of using a transmit inactivity period, in accordance with the present disclosure.

Although NR generally offers a significant energy efficiency improvement per gigabyte over previous generations (for example, LTE), new NR use cases that demand high data rates and/or the adoption of millimeter wave frequencies may involve more network sites, greater network density, more network antennas, larger bandwidths, and/or more frequency bands, which could potentially lead to a more efficient wireless network that nonetheless has higher energy expectations and/or causes more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). Most energy consumption and/or energy costs come from powering a RAN, which accounts for about half of the energy consumed by a wireless network. Accordingly, networks are being designed to be more energy efficient and environmentally responsible. These designs may include the use of a sleep state by a network entity, where the network entity powers down radio components or other components (partially or fully) at times to reduce energy consumption.

In some aspects, a network entity may have opportunities to enter an NES mode. During the NES mode, the network entity may reduce power consumption. The network entity may reduce power consumption by using one or more techniques to adapt transmission and/or reception in time, frequency, spatial, and/or power domains. This may include adjusting (e.g., reducing) a transmit power, a quantity of antenna elements (and associated panels or transmit receive units (TxRUs)) that are used, and/or an operating bandwidth. Beam selection may also be adjusted, such as selecting a narrower beam or turning off some beam directions. The reduction of the power for transmitting may be part of entering a sleep state, where the network entity enters a transmit inactive state or a receive inactive state. By contrast, an active state or awake state may include a state of processing (e.g., decoding and/or demodulating) downlink signals, uplink signals, and/or channels. The amount of power that the network entity consumes during an awake state may scale (increase or decrease) based at least in part on a quantity of component carriers (CCs), resource utilization, a quantity of antenna ports, a quantity of spatial layers, and/or a quantity of antenna elements.

Example 400 shows how the network entity may ramp power down from an active state to a sleep state and ramp power back up to an active state. As the time between active states increases, more components can be turned off (power withdrawn) to conserve more power, including a radio (radio components) that is used for transmission and/or reception. For example, the network entity may switch off the radio frequency (RF) part and/or a broadband part of a transmit chain, such that the network entity will not transmit any communications. Switching between a transmit (downlink) active state (transmitting) and a transmit inactive state (not transmitting) may be an operation of a network entity discontinuous transmission (DTX) mode. During the inactive transmit state, there are no downlink transmissions and the network entity can enter a sleep state. During the active transmit state, downlink transmissions are possible, and the network entity cannot enter the sleep state. Switching between a receive (uplink) active state (receiving) and a receive inactive state (not receiving) may be an operation of a network entity discontinuous reception (DRX) mode.

The network entity may reduce power by varying amounts. For example, a sleep state may include varying levels of sleep, such as a micro sleep, a light sleep, or a deep sleep. A micro sleep may cause the network entity to use a reduced amount of power for the radio as compared to the active state. This reduction in power may be much less than the reduction in power for a deep sleep (e.g., a deep sleep may have a reduction in power that is 14 times that of a micro sleep). However, a micro sleep may have very little transition time (e.g., less than 1 millisecond (ms)) and may use little transition energy. A light sleep may be a sleep level between a micro sleep and a deep sleep, with a power reduction that is, for example, half that of a deep sleep. A light sleep may have a slower transition time (e.g., 6 ms) than a micro sleep, but may still be quicker than a deep sleep. A light sleep may cause the network entity to use additional transition energy (relative power vs. ms) that can be about 20 times that of a micro sleep. A deep sleep may have the longest sleep period and/or the greatest energy reduction. The deep sleep may also have the longest transition time (e.g., 20 ms) and cause the network entity to use the greatest amount of energy for transition (e.g., about 100 times that of the micro sleep).

In some aspects, the NES mode may also include an energy harvesting (EH) mode. In the EH mode, a network entity may obtain energy from an alternative source other than a regular power source. Alternative sources may include renewable energy sources, such as solar power, vibration, or thermal energy.

As indicated above, FIG. 4 is provided as an example. Other examples may differ from what is described with respect to FIG. 4.

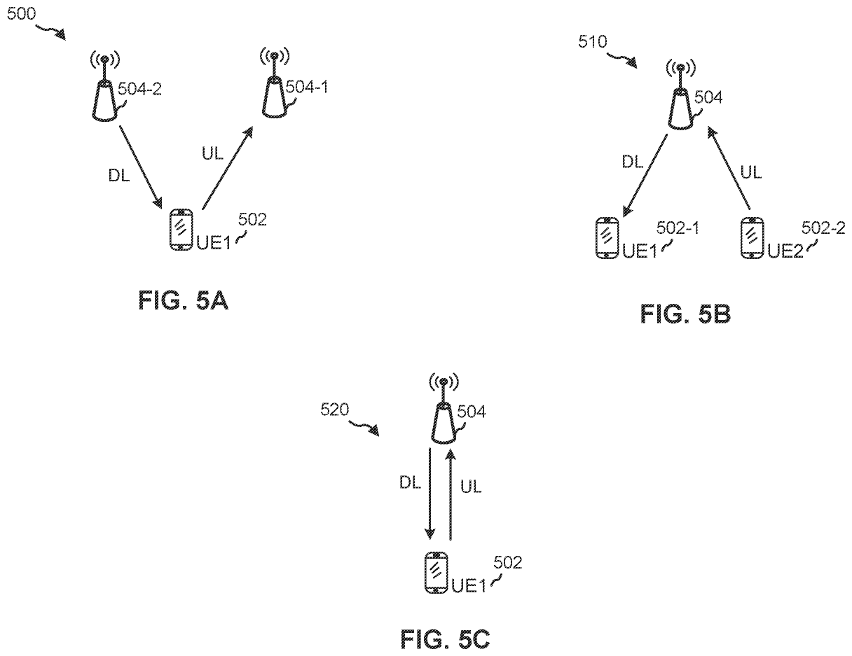

FIGS. 5A-5C are diagrams illustrating examples of full-duplex (FD) communication in accordance with the present disclosure. A first full-duplex scenario 500 depicted in FIG. 5A includes a UE1 502 and two base stations (e.g., network entities or TRPs) 504-1, 504-2, where the UE1 502 is sending uplink transmissions to base station 504-1 and is receiving downlink transmissions from base station 504-2. In the first full-duplex scenario 500 of FIG. 5A, FD is enabled for the UE1 502, but not for the base stations 504-1, 504-2. A second full-duplex scenario 510 depicted in FIG. 5B includes two UEs, shown as UE1 502-1 and UE2 502-2, and a base station 504, where the UE1 502-1 is receiving a downlink transmission from the base station 504 and the UE2 502-2 is transmitting an uplink transmission to the base station 504. In the second full-duplex scenario 510, FD is enabled for the base station 504, but not for UE1 502-1 and UE2 502-2. A third full-duplex scenario 520 is depicted in FIG. 5C that includes a UE1 502 and a base station 504, where the UE1 502 is receiving a downlink transmission from the base station 504 and the UE1 502 is transmitting an uplink transmission to the base station 504. In the third full-duplex scenario 520, FD is enabled for both the UE1 502 and the base station 504.

As indicated above, FIGS. 5A-5C provide some examples. Other examples may differ from what is described with regard to FIGS. 5A-5C.

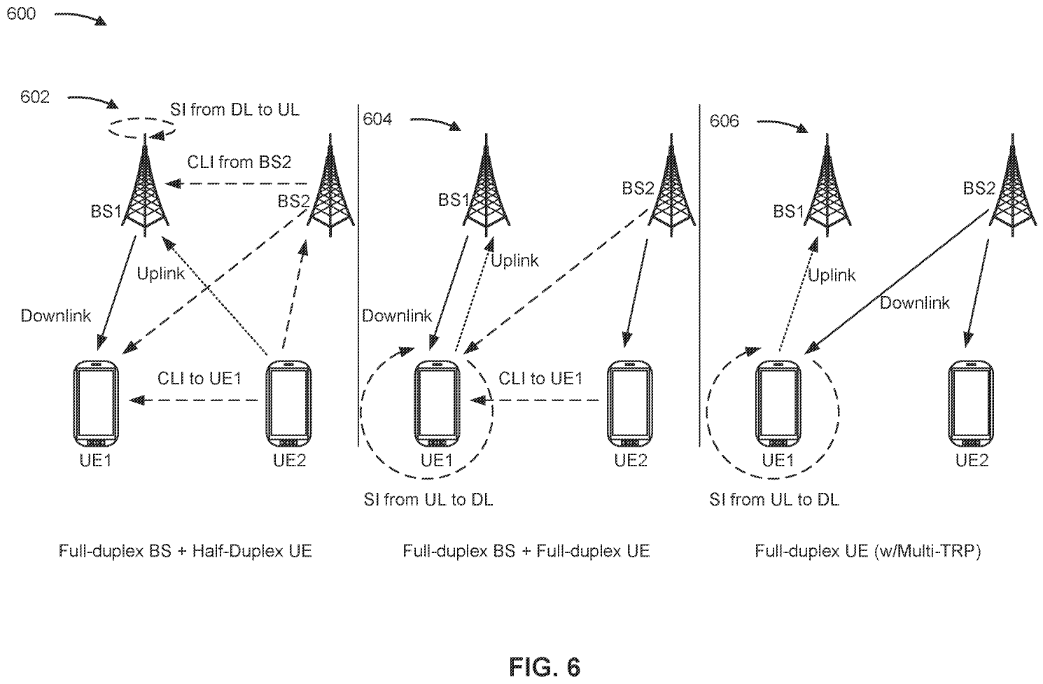

FIG. 6 is a diagram illustrating an example of full-duplex communication modes 600, in accordance with the present disclosure. In a first mode 602, a first network entity (shown as BS1) and a second network entity (shown as BS2) may be full-duplex devices (e.g., may be capable of communicating in a full-duplex manner). A first UE (shown as UE1) and a second UE (shown as UE2) may be half duplex UEs (e.g., may not be capable of communicating in a full-duplex manner). The first network entity may perform downlink transmissions to the first UE, and the first network entity may receive uplink transmissions from the second UE. The first network entity may experience system information (SI) from a downlink to an uplink based at least in part on the downlink transmissions to the first UE and the uplink transmissions received from the second UE. The first network entity may experience CLI from the second network entity. CLI may also occur when a network entity configures different time division duplex (TDD) uplink and downlink slots to nearby UEs. For example, the first UE may experience CLI from the second network entity and the second UE. If the first UE's downlink symbol collides with at least one uplink symbol of the second UEs, the first UE may be considered a “victim UE” and the second UE may be considered an “aggressor UE”.

In a second mode 604, a first network entity and a second network entity may be full-duplex devices. A first UE and a second UE may be full-duplex UEs. The first network entity may perform downlink transmissions to the first UE, and the first network entity may receive uplink transmissions from the first UE. The first UE may experience SI from an uplink to a downlink based at least in part on the downlink transmissions from the first network entity and the uplink transmissions to the first network entity. The first UE may experience CLI from the second network entity and the second UE. CLI may occur between two UEs on the same cell or on different cells.

In a third mode 606, a first UE and a second UE may be full-duplex UEs and may communicate in a multiple TRP (multi-TRP) configuration. A first network entity may receive uplink transmissions from the first UE, and a second network entity may perform downlink transmissions to the first UE and the second UE. The first UE may experience SI from an uplink to a downlink based at least in part on the uplink transmissions to the first network entity and the downlink transmissions from the second network entity.

A victim UE may measure CLI from an aggressor UE. The aggressor UE may not transmit anything dedicated for CLI measurement by a victim UE and does not know if an uplink transmission is measured by a victim UE. The victim UE may measure CLI if the network entity configures one or more CLI measurement resources for CLI measurement.

CLI measurements may be different for an NES mode (e.g., power reduction, EH mode) of a network entity than for a non-NES mode (e.g., regular operation mode, non-power reduction, non-EH mode) of the network entity. During an NES mode, the network entity may use less bandwidth (e.g., 5 MHz instead of 20 MHz) and a lower transmit power than during a non-NES mode. If CLI is measured during a non-NES mode, the CLI measurements may be inaccurate when the network entity is operating in an NES mode. Likewise, if CLI is measured during an NES mode, the CLI measurements may be inaccurate when the network entity is operating in a non-NES mode. Inaccurate CLI reports may result in inaccurate scheduling and transmit power adjustments, which can degrade communications with increased interference and waste power with overpowered transmissions. Degraded communications waste power, processing resources, and signaling resources.

As indicated above, FIG. 6 is provided as an example. Other examples may differ from what is described with regard to FIG. 6.

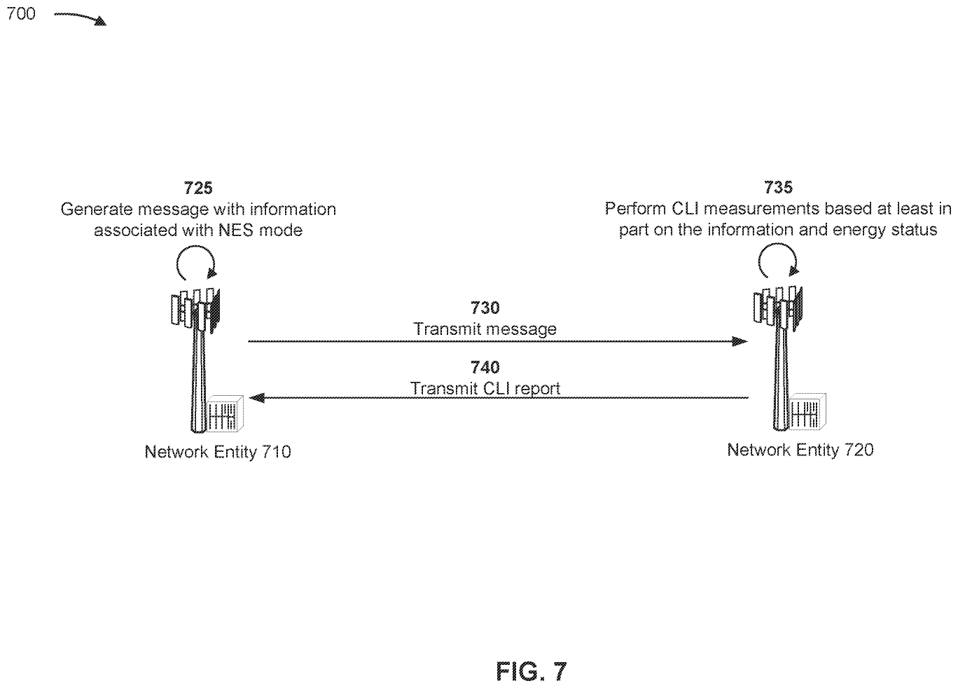

FIG. 7 is a diagram illustrating an example 700 of transmitting information associated with a network entity NES mode, in accordance with the present disclosure. Example 700 shows a first network entity 710 (e.g., base station 110) and a second network entity 720 (e.g., base station 110) that may communicate with each other via a wireless network (e.g., wireless network 100). As network entity 720 is measuring CLI affecting its communications, network entity 720 may be considered the “victim” network entity and network entity 710 may be considered the “aggressor” network entity that is transmitting and causing CLI. Network entity 710 may transmit CLI reference signals (CLI-RSs) such that network entity 720 can measure CLI.

According to various aspects described herein, network entity 710 may transmit a message with information associated with an NES mode of network entity 710. The NES mode information may be associated with a timing of CLI measurement resources, including transmission or reception windows of CLI-RSs or CLI occasions for measuring CLI. That is, the information about the NES mode may correspond to when CLI measurements are performed such that network entity 720 has information about whether network entity 710 is in an NES mode or a non-NES mode when CLI measurements are taken. The information may include a transmission power state (e.g. downlink (DL) power back-off), a quantity of antenna elements or panels, an operating bandwidth for DL and uplink (UL) communication, a subset of beam directions, combination of the information elements (e.g., subset of beam direction with specific power back-off at subset of frequency resources of operating bandwidth), and/or other information about a state of network entity 710 during an NES mode. The information may also indicate an EH state and details about the EH state (e.g., duration, periodicity, rate of energy harvesting, alternative power source). The information may indicate a full-duplex mode of the network entity 710, including whether network entity 710 is operating in a half-duplex, full-duplex, or a subband full-duplex mode (SBFD) mode (subbands of different directions frequency division multiplexed in the same slot). The information may indicate an uplink/downlink subband configuration, such as an uplink/downlink slot pattern.

Network entity 720 may measure CLI at the CLI measurement resources and transmit a CLI report that is based at least in part on CLI measurements and the information about an NES mode of network entity 710. Because network entity 710 provides NES mode information that is associated with a timing of CLI measurements, network entity 720 may provide more accurate CLI reports for different NES operating modes of network entity 710. Communications improve, and power and signaling resources are conserved. In some aspects, network entity 710 may perform CLI measurements during an NES mode.

As shown by reference number 725, network entity 710 may generate the message. As shown by reference number 730, network entity 710 may transmit the message. In some aspects, the message may include a CLI measurement configuration that configures network entity 720 for CLI measurements. The CLI measurement configuration may indicate a first set of CLI measurement resources (e.g., time and frequency resources, reference signals) for the NES mode of network entity 710 and a second set of CLI measurement resources for the non-NES mode of network entity 710.

Network entity 710 may transmit the message based at least in part on a triggering event (e.g., energy level exceeding an energy threshold, dynamic change in EH mode or NES mode). Network entity 710 may transmit the message via a backhaul or wirelessly OTA. If network entity 710 and network entity 720 belong to the same CU, F1 signaling may be used. If network entity 710 and network entity 720 belong to two CUs, F1 or Xn signaling may be used. Network entity 710 may use a central coordinator for network entity 710 and network entity 720. Network entity 710 may use semi-static signaling (e.g., semi-static switching pattern of NES modes).

As shown by reference number 735, network entity 720 may perform CLI measurements based at least in part on the information in the message about the NES mode of network entity 710. Network entity 720 may use different CLI measurements resources based at least in part on the NES mode of network entity 710. Network entity 720 may use less, more, or different CLI measurement resources if network entity 710 is an NES mode than when network entity 710 is in a non-NES mode.

In some aspects, network entity 720 may perform the CLI measurements based at least in part on an energy status (e.g., NES operating mode, energy level, energy consumption level, energy harvesting level, energy consumption history) of network entity 720. If network entity 720 is in an NES mode, network entity 720 may not perform CLI measurements or may perform CLI measurements differently.

As shown by reference number 740, network entity 720 may transmit a CLI report that indicates one or more of the CLI measurements. In some aspects, the CLI report may indicate the NES operating mode (NES mode or non-NES mode) of network entity 710 for the CLI measurements included in the CLI report. The NES operating mode may be associated with the timing of CLI measurements. One set of CLI measurements may be indicated as being performed during an NES mode of network entity 710 and another set of CLI measurements may be indicated as being performed during a non-NES mode of network entity 710.

In some aspects, the CLI report may indicate an operating mode (e.g., NES mode, non-NES mode, reception mode) of network entity 720. That is, network entity 720 may also be operating in an NES mode when measuring CLI. The reception mode of network entity 720 may include network entity 720 operating with a different bandwidth for an NES mode or an EH mode of network entity 720 than for a non-NES mode or a non-EH mode of network entity 720. Network entity 720 may operate with a reduced quantity of antennal elements or antenna panels (e.g., turn off some antenna elements, which affects beamforming) or with a subset of receive beams (e.g., measure CLI in specific receive beams). The CLI report may indicate an energy status of network entity 720 or other information such as the reduced quantity of antenna elements, an operating bandwidth, a beam subset, or other information about an NES operating mode of network entity 720 for CLI measurements. The CLI report may indicate a full-duplex mode of network entity 710 and/or network entity 720 for the CLI measurements.

As indicated above, FIG. 7 is provided as an example. Other examples may differ from what is described with regard to FIG. 7.

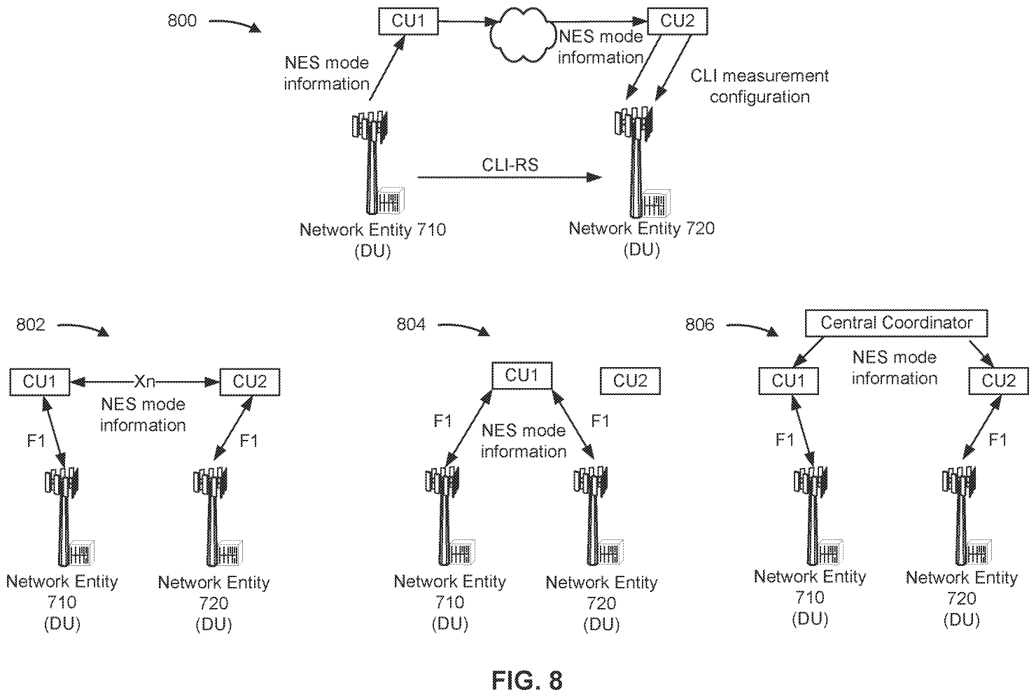

FIG. 8 is a diagram illustrating examples 800, 802, 804, and 806 of exchanging information about NES modes, in accordance with the present disclosure.

Network entity 710 may exchange information about an NES mode with network entity 720 in various ways. The information about the NES mode may be associated with CLI measurement occasions. Example 800 shows that network entity 710 (DU) is to transmit a CLI-RS to network entity 720 (DU). Network entity 710 may transmit a message with the information about the NES mode of network entity 710 to a CU (CU1) for network entity 710. CU1 may transmit the message to a CU (CU2) for network entity 720 through the internet, the cloud, or a core network. CU2 may transmit the message to network entity 720 (DU). CU2 may also transmit a CLI measurement configuration (e.g., resource time/frequency, metric) to network entity 720. The information about the NES mode of network entity 710 may be transmitted in or with the CLI measurement configuration.

Example 802 shows that network entity 710 may transmit the message via an F1 interface to CU1. CU1 may transmit the message to CU2 directly via an Xn interface. CU2 may transmit the message via an F1 interface to network entity 720. Similarly, network entity 720 may transmit a CLI report or another message with information about an NES mode of network entity 720 to network entity 710 via the CUs and the Xn interface.

Example 804 shows that network entity 710 and network entity 720 may share a same CU (CU1). Network entity 710 may transmit the message to network entity 720 via CU1. Network entity 720 may also transmit information to network entity 710 via CU1.

Example 806 shows a central coordinator for network entity 710 and network entity 720. CU1 may transmit the message to CU2 via the central coordinator. CU2 may also transmit information to CU1 via the central coordinator.

As indicated above, FIG. 8 is provided as an example. Other examples may differ from what is described with regard to FIG. 8.

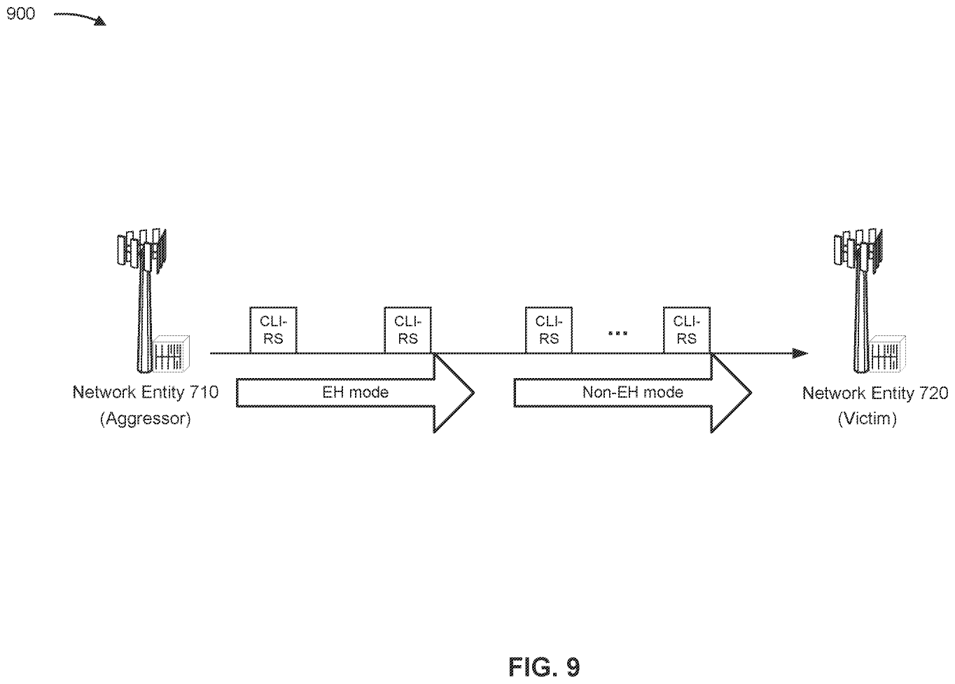

FIG. 9 is a diagram illustrating an example 900 of NES mode information associated with CLI measurement resources, in accordance with the present disclosure.

In some aspects, network entity 720 (victim) may perform CLI measurements based at least in part on an NES mode of network entity 710 (aggressor). This may include when network entity 710 is in the NES mode or in a non-NES mode. The NES mode may include an EH mode, and the non-NES mode may include a non-EH mode. Network entity 720 may receive a message (e.g., in a CLI measurement configuration) with information about an NES mode of network entity 710. With this information, network entity 720 may perform CLI measurements that are based at least in part an NES operating mode of network entity 710, whether the NES operating mode is NES or non-NES. That is, network entity 720 may perform NES-dependent or EH-dependent measurements. There may be one CLI measurement for a non-NES mode or a non-EH mode and another CLI measurement for an NES mode or an EH mode.

Network entity 720 may perform CLI measurements using CLI measurement resources (e.g., time and frequency resources for CLI measurement occasions, specific CLI-RSs). Example 900 shows CLI-RSs that are transmitted during an EH mode and CLI-RSs that are transmitted during a non-EH mode. Network entity 720 may note for CLI measurements of the CLI-RSs whether the CLI measurement was during an EH mode or a non-EH mode of network entity 710. Network entity 720 may use CLI measurement resources that are specific to an EH mode and different CLI measurement resources that are specific to a non-EH mode. By distinguishing CLI-RSs based at least in part on an EH mode, network entity 720 may provide a more accurate CLI report.

As indicated above, FIG. 9 is provided as an example. Other examples may differ from what is described with regard to FIG. 9.

FIG. 10 is a diagram illustrating an example process 1000 performed, for example, by a first network entity, in accordance with the present disclosure. Example process 1000 is an example where the first network entity (e.g., base station 110, network entity 710) performs operations associated with indicating a NES mode associated with CLI measurements.

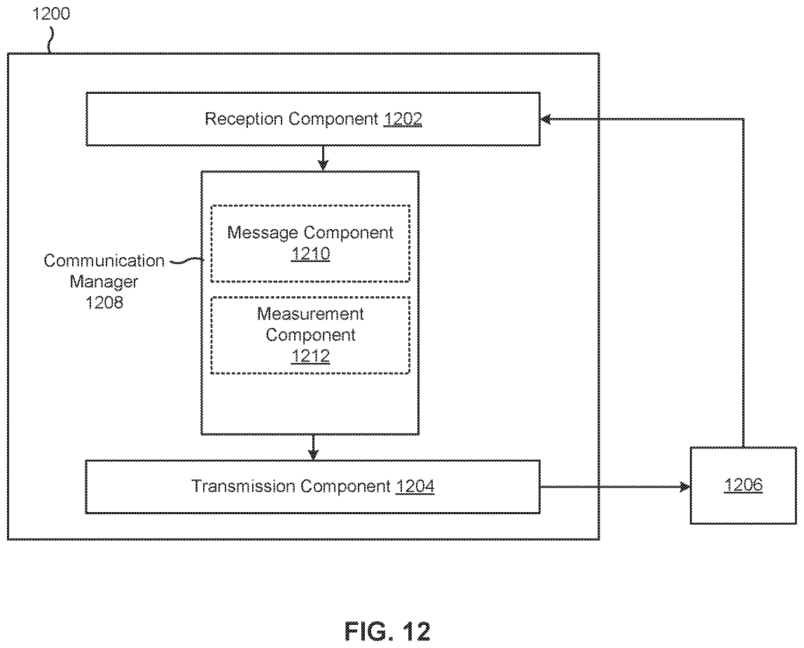

As shown in FIG. 10, in some aspects, process 1000 may include generating a message that includes information associated with an NES mode of the first network entity in association with a timing of CLI measurement resources (block 1010). For example, the first network entity (e.g., using communication manager 1208 and/or message component 1210 depicted in FIG. 12) may generate a message that includes information associated with an NES mode of the first network entity in association with a timing of CLI measurement resources, as described above, for example, with reference to FIGS. 7, 8, and 9.

As further shown in FIG. 10, in some aspects, process 1000 may include transmitting the message to a second network entity (block 1020). For example, the first network entity (e.g., using communication manager 1208 and/or transmission component 1204 depicted in FIG. 12) may transmit the message to a second network entity, as described above, for example, with reference to FIGS. 7, 8, and 9.

Process 1000 may include additional aspects, such as any single aspect or any combination of aspects described below and/or in connection with one or more other processes described elsewhere herein.

In a first aspect, the message includes a CLI resource measurement configuration.

In a second aspect, alone or in combination with the first aspect, the CLI resource measurement configuration indicates a first set of CLI measurement resources for the NES mode and a second set of CLI measurement resources for a non-NES mode of the first network entity.

In a third aspect, alone or in combination with one or more of the first and second aspects, process 1000 includes receiving a CLI report from the second network entity that indicates an NES operating mode of the second network entity.

In a fourth aspect, alone or in combination with one or more of the first through third aspects, the message indicates a full-duplex mode of the first network entity, a subband configuration of the first network entity, or a combination thereof.

In a fifth aspect, alone or in combination with one or more of the first through fourth aspects, process 1000 includes receiving a CLI report from the second network entity that indicates a full-duplex mode of the second network entity.

In a sixth aspect, alone or in combination with one or more of the first through fifth aspects, transmitting the message includes transmitting the message based at least in part on detection of a triggering event.

In a seventh aspect, alone or in combination with one or more of the first through sixth aspects, transmitting the message includes transmitting the message via wireless signaling.

In an eighth aspect, alone or in combination with one or more of the first through seventh aspects, transmitting the message includes transmitting the message via a backhaul between the first network entity and the second network entity.

In a ninth aspect, alone or in combination with one or more of the first through eighth aspects, transmitting the message includes transmitting the message via a central coordinator.

In a tenth aspect, alone or in combination with one or more of the first through ninth aspects, transmitting the message includes transmitting the message via a CU for the first network entity.

In an eleventh aspect, alone or in combination with one or more of the first through tenth aspects, process 1000 includes performing CLI measurements while the first network entity is in the NES mode.

In a twelfth aspect, alone or in combination with one or more of the first through eleventh aspects, the NES mode includes an adaptation of power, an operating bandwidth, a quantity of antenna elements, beam selection, or any combination thereof.

In a thirteenth aspect, alone or in combination with one or more of the first through twelfth aspects, the NES mode includes an EH mode and a non-NES mode includes a non-EH mode.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a second network entity, in accordance with the present disclosure. Example process 1100 is an example where the second network entity (e.g., base station 110, network entity 720) performs operations associated with measuring and reporting CLI based at least in part on NES mode information from a first network entity.

As shown in FIG. 11, in some aspects, process 1100 may include receiving a message that includes information associated with an NES mode of a first network entity in association with a timing of CLI measurement resources (block 1110). For example, the second network entity (e.g., using communication manager 1208 and/or reception component 1202 depicted in FIG. 12) may receive a message that includes information associated with an NES mode of a first network entity in association with a timing of CLI measurement resources, as described above, for example, with reference to FIGS. 7, 8, and 9.

As further shown in FIG. 11, in some aspects, process 1100 may include performing CLI measurements based at least in part on the information and an energy status of the second network entity (block 1120). For example, the second network entity (e.g., using communication manager 1208 and/or measurement component 1212 depicted in FIG. 12) may perform CLI measurements based at least in part on the information and an energy status of the second network entity, as described above, for example, with reference to FIGS. 7, 8, and 9.

Process 1100 may include additional aspects, such as any single aspect or any combination of aspects described below and/or in connection with one or more other processes described elsewhere herein.

In a first aspect, performing the CLI measurements includes adjusting the CLI measurements during the NES mode of the first network entity.

In a second aspect, alone or in combination with the first aspect, performing the CLI measurements includes using a first CLI measurement configuration during the NES mode of the first network entity and a second CLI measurement configuration during a non-NES mode of the first network entity.

In a third aspect, alone or in combination with one or more of the first and second aspects, the message includes a CLI resource measurement configuration.

In a fourth aspect, alone or in combination with one or more of the first through third aspects, the CLI resource measurement configuration indicates a first set of CLI measurement resources for the NES mode of the first network entity and a second set of CLI measurement resources for a non-NES mode of the first network entity, and performing the CLI measurements includes measuring CLI using the first set of CLI measurement resources during the NES mode and measuring CLI using the second set of CLI measurement resources during the non-NES mode.

In a fifth aspect, alone or in combination with one or more of the first through fourth aspects, process 1100 includes transmitting a CLI report from the second network entity that indicates an NES operating mode of the second network entity.

In a sixth aspect, alone or in combination with one or more of the first through fifth aspects, process 1100 includes transmitting a CLI report from the second network entity that indicates a full-duplex mode of the second network entity associated with the performing of the CLI measurements.

In a seventh aspect, alone or in combination with one or more of the first through sixth aspects, the message indicates a full-duplex mode of the first network entity, a subband configuration of the first network entity, or a combination thereof.

In an eighth aspect, alone or in combination with one or more of the first through seventh aspects, process 1100 includes transmitting a CLI report that indicates a subset of antenna elements used for measuring CLI.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a network entity (e.g., base station 110, network entity 710, network entity 720), or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the network entity described in connection with FIG. 2. The communication manager 1208 may be, or be similar to, the communication manager 150 depicted in FIGS. 1 and 2. For example, in some aspects, the communication manager 1208 may be configured to perform one or more of the functions described as being performed by the communication manager 150. In some aspects, the communication manager 1208 may include the reception component 1202 and/or the transmission component 1204. The communication manager 1208 may include a message component 1210 and/or a measurement component 1212, among other examples.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10, process 1100 of FIG. 11, or a combination thereof. In some aspects, the apparatus 1200 and/or one or more components shown in FIG. 12 may include one or more components of the first network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the first network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the first network entity described in connection with FIG. 2. In some aspects, the transmission component 1204 may be co-located with the reception component 1202 in a transceiver.

In some aspects, the network entity may be a first network entity. The message component 1210 may generate a message that includes information associated with an NES mode of the first network entity in association with a timing of CLI measurement resources. The transmission component 1204 may transmit the message to a second network entity.

The reception component 1202 may receive a CLI report from the second network entity that indicates an NES operating mode of the second network entity. The reception component 1202 may receive a CLI report from the second network entity that indicates a full-duplex mode of the second network entity. The measurement component 1212 may perform CLI measurements while the first network entity is in the NES mode.

In some aspects, the network entity may be the second network entity. The reception component 1202 may receive a message that includes information associated with an NES mode of a first network entity in association with a timing of CLI measurement resources. The measurement component 1212 may perform CLI measurements based at least in part on the information and an energy status of the second network entity.

The transmission component 1204 may transmit a CLI report from the second network entity that indicates an NES operating mode of the second network entity. The transmission component 1204 may transmit a CLI report from the second network entity that indicates a full-duplex mode of the second network entity associated with the performing of the CLI measurements. The transmission component 1204 may transmit a CLI report that indicates a subset of antenna elements used for measuring CLI.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first network entity, comprising: generating a message that includes information associated with a network energy saving (NES) mode of the first network entity in association with a timing of cross-link interference (CLI) measurement resources; and transmitting the message to a second network entity.

Aspect 2: The method of Aspect 1, wherein the message includes a CLI resource measurement configuration.

Aspect 3: The method of Aspect 2, wherein the CLI resource measurement configuration indicates a first set of CLI measurement resources for the NES mode and a second set of CLI measurement resources for a non-NES mode of the first network entity.

Aspect 4: The method of any of Aspects 1-3, further comprising receiving a CLI report from the second network entity that indicates an NES operating mode of the second network entity.

Aspect 5: The method of any of Aspects 1-4, wherein the message indicates a full-duplex mode of the first network entity, a subband configuration of the first network entity, or a combination thereof.

Aspect 6: The method of any of Aspects 1-5, further comprising receiving a CLI report from the second network entity that indicates a full-duplex mode of the second network entity.

Aspect 7: The method of any of Aspects 1-6, wherein transmitting the message includes transmitting the message based at least in part on detection of a triggering event.

Aspect 8: The method of any of Aspects 1-7, wherein transmitting the message includes transmitting the message via wireless signaling.

Aspect 9: The method of any of Aspects 1-8, wherein transmitting the message includes transmitting the message via a backhaul between the first network entity and the second network entity.

Aspect 10: The method of any of Aspects 1-9, wherein transmitting the message includes transmitting the message via a central coordinator.

Aspect 11: The method of any of Aspects 1-10, wherein transmitting the message includes transmitting the message via a central unit (CU) for the first network entity.

Aspect 12: The method of any of Aspects 1-11, further comprising performing CLI measurements while the first network entity is in the NES mode.

Aspect 13: The method of any of Aspects 1-12, wherein the NES mode includes an adaptation of power, an operating bandwidth, a quantity of antenna elements, beam selection, or any combination thereof.

Aspect 14: The method of any of Aspects 1-13, wherein the NES mode includes an energy harvesting (EH) mode and a non-NES mode includes a non-EH mode.

Aspect 15: A method of wireless communication performed by a second network entity, comprising: receiving a message that includes information associated with a network energy saving (NES) mode of a first network entity in association with a timing of cross-link interference (CLI) measurement resources; and performing CLI measurements based at least in part on the information and an energy status of the second network entity.

Aspect 16: The method of Aspect 15, wherein performing the CLI measurements includes adjusting the CLI measurements during the NES mode of the first network entity.

Aspect 17: The method of Aspect 15 or 16, wherein performing the CLI measurements includes using a first CLI measurement configuration during the NES mode of the first network entity and a second CLI measurement configuration during a non-NES mode of the first network entity.

Aspect 18: The method of any of Aspects 15-17, wherein the message includes a CLI resource measurement configuration.

Aspect 19: The method of Aspect 18, wherein the CLI resource measurement configuration indicates a first set of CLI measurement resources for the NES mode of the first network entity and a second set of CLI measurement resources for a non-NES mode of the first network entity, and wherein performing the CLI measurements includes measuring CLI using the first set of CLI measurement resources during the NES mode and measuring CLI using the second set of CLI measurement resources during the non-NES mode.

Aspect 20: The method of any of Aspects 15-19, further comprising transmitting a CLI report from the second network entity that indicates an NES operating mode of the second network entity.

Aspect 21: The method of any of Aspects 15-20, further comprising transmitting a CLI report from the second network entity that indicates a full-duplex mode of the second network entity associated with the performing of the CLI measurements.

Aspect 22: The method of any of Aspects 15-21, wherein the message indicates a full-duplex mode of the first network entity, a subband configuration of the first network entity, or a combination thereof.

Aspect 23: The method of any of Aspects 15-22, further comprising transmitting a CLI report that indicates a subset of antenna elements used for measuring CLI.

Aspect 24: An apparatus for wireless communication at a device, comprising a processor; one or more memories coupled with the processor; and instructions stored in the one or more memories and executable by the processor to cause the apparatus to perform the method of one or more of Aspects 1-23.

Aspect 25: A device for wireless communication, comprising one or more memories and one or more processors coupled to the one or more memories, the one or more processors individually or collectively configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a first network entity, comprising:
generating a message that includes information associated with a network energy saving (NES) mode of the first network entity in association with a timing of cross-link interference (CLI) measurement resources; and
transmitting the message to a second network entity.

2. The method of claim 1, wherein the message includes a CLI resource measurement configuration.

3. The method of claim 2, wherein the CLI resource measurement configuration indicates a first set of CLI measurement resources for the NES mode and a second set of CLI measurement resources for a non-NES mode of the first network entity.

4. The method of claim 1, further comprising receiving a CLI report from the second network entity that indicates an NES operating mode of the second network entity.

5. The method of claim 1, wherein the message indicates a full-duplex mode of the first network entity, a subband configuration of the first network entity, or a combination thereof.

6. The method of claim 1, further comprising receiving a CLI report from the second network entity that indicates a full-duplex mode of the second network entity.

7. The method of claim 1, wherein transmitting the message includes transmitting the message based at least in part on detection of a triggering event.

8. The method of claim 1, wherein transmitting the message includes transmitting the message via wireless signaling.

9. The method of claim 1, wherein transmitting the message includes transmitting the message via a backhaul between the first network entity and the second network entity.

10. The method of claim 1, wherein transmitting the message includes transmitting the message via a central coordinator.

11. The method of claim 1, wherein transmitting the message includes transmitting the message via a central unit (CU) for the first network entity.

12. The method of claim 1, further comprising performing CLI measurements while the first network entity is in the NES mode.

13. The method of claim 1, wherein the NES mode includes an adaptation of power, an operating bandwidth, a quantity of antenna elements, beam selection, or any combination thereof.

14. The method of claim 1, wherein the NES mode includes an energy harvesting (EH) mode and a non-NES mode includes a non-EH mode.

15. A method of wireless communication performed by a second network entity, comprising:
receiving a message that includes information associated with a network energy saving (NES) mode of a first network entity in association with a timing of cross-link interference (CLI) measurement resources; and
performing CLI measurements based at least in part on the information and an energy status of the second network entity.

16. The method of claim 15, wherein performing the CLI measurements includes adjusting the CLI measurements during the NES mode of the first network entity.

17. The method of claim 15, wherein performing the CLI measurements includes using a first CLI measurement configuration during the NES mode of the first network entity and a second CLI measurement configuration during a non-NES mode of the first network entity.

18. The method of claim 15, wherein the message includes a CLI resource measurement configuration.

19. The method of claim 18, wherein the CLI resource measurement configuration indicates a first set of CLI measurement resources for the NES mode of the first network entity and a second set of CLI measurement resources for a non-NES mode of the first network entity, and wherein performing the CLI measurements includes measuring CLI using the first set of CLI measurement resources during the NES mode and measuring CLI using the second set of CLI measurement resources during the non-NES mode.

20. The method of claim 15, further comprising transmitting a CLI report from the second network entity that indicates an NES operating mode of the second network entity.

21. The method of claim 15, further comprising transmitting a CLI report from the second network entity that indicates a full-duplex mode of the second network entity associated with the performing of the CLI measurements.

22. The method of claim 15, wherein the message indicates a full-duplex mode of the first network entity, a subband configuration of the first network entity, or a combination thereof.

23. The method of claim 15, further comprising transmitting a CLI report that indicates a subset of antenna elements used for measuring CLI.

24. An apparatus of a first network entity for wireless communication, comprising:
one or more memories; and
one or more processors coupled to the one or more memories, the one or more processors individually or collectively configured to:
generate a message that includes information associated with a network energy saving (NES) mode of the first network entity in association with a timing of cross-link interference (CLI) measurement resources; and
transmit the message to a second network entity.

25. The apparatus of claim 24, wherein the message includes a CLI resource measurement configuration.

26. The apparatus of claim 25, wherein the CLI resource measurement configuration indicates a first set of CLI measurement resources for the NES mode and a second set of CLI measurement resources for a non-NES mode of the first network entity.

27. The apparatus of claim 24, wherein the one or more processors are individually or collectively configured to receive a CLI report from the second network entity that indicates an NES operating mode of the second network entity.

28. An apparatus of a second network entity for wireless communication, comprising:
one or more memories; and
one or more processors coupled to the one or more memories, the one or more processors individually or collectively configured to:
receive a message that includes information associated with a network energy saving (NES) mode of a first network entity in association with a timing of cross-link interference (CLI) measurement resources; and
perform CLI measurements based at least in part on the information and an energy status of the second network entity.

29. The apparatus of claim 28, wherein the one or more processors, to perform the CLI measurements, are individually or collectively configured to adjust the CLI measurements during the NES mode of the first network entity.

30. The apparatus of claim 28, wherein the one or more processors, to perform the CLI measurements, are individually or collectively configured to use a first CLI measurement configuration during the NES mode of the first network entity and a second CLI measurement configuration during a non-NES mode of the first network entity.
